(19) United States
(12) Patent Application Publication
(10) Pub. No.: US 2011/0301990 A1
(43) Pub. Date: Dec. 8, 2011

(54) PRICING AND SERVICE SUSTAINABILITY APPLICATION

(75) Inventors: Matthew Joseph Hickey, Boulder, CO (US); Jamie Sue Sabbach, Boulder, CO (US); John J. Hickey, Silverthorne, CO (US); Brian E. Wilderson, Broomfield, CO (US)

(73) Assignee: ePRepSolutions, LLC, Boulder, CO (US)

(21) Appl. No.: 13/104,261

(22) Filed: May 10, 2011

Related U.S. Application Data
(60) Provisional application No. 61/333,102, filed on May 10, 2010.

(51) Int. Cl. G06Q 10/00

(52) U.S. Cl. 705/7.12

(57) ABSTRACT

Provided herein is a financial management application and associated services specific to the parks and recreation sector. The application and/or services will allow organizations to more efficiently and accurately create and manage their budgets. Aspects of the inventions include providing a comprehensive cost recovery software tool specifically designed for the needs of a particular organization. The systems and method (i.e., utilities) provided herein are primarily designed for use by government and non-profit organizations in assessing the direct and indirect costs of operations for the services they provide to communities.

### CROSS REFERENCE TO RELATED APPLICATION

This application claims priority under 35 USC §119 to U.S. Provisional Application No. 61/333,102 having a filing date of May 10, 2010, the entire contents of which is incorporated herein by reference.

### BACKGROUND

Governmental parks and recreation departments have historically existed in an environment with loose, over stuffed budgets. Such departments historically have not accurately tracked, priced or recovered the services they provide. However, recent economic conditions have forever changed this environment and left many organizations scrambling to improve their financial management. One recurring problem for these entities is determining feel levels for various different products and services, which that represent the true costs of such products and services.

Current systems within these agencies do not provide the insight needed to make the best decisions in this challenging economic environment. Agencies are grappling with dynamics such as: increased competition for the “leisure dollar” as households have endless in-home and out-of-home options for their discretionary budgets; increased operating expenses (e.g., utilities, fuel, personnel, supplies); general public disinterest in or support for service reductions or increased fees and charges; competing with “essential services” such as safety and health services for a smaller portion of available subsidies; and enhanced consumer and community interest in organizational accountability for tax dollar expenditures.

Accordingly, there is a need for parks and recreation entities across the country make logical and defensible management decisions. For many years, existing tools and protocols have been identified as antiquated and ill-equipped to adapt to shifting societal circumstances.

### SUMMARY

Provided herein is a financial management application and associated services specific to the parks and recreation sector. The application and/or services will allow organizations to more efficiently and accurately create and manage their budgets. Aspects of the inventions include providing a comprehensive cost recovery software tool specifically designed for the needs of a particular organization. The systems and method (i.e., utilities) provided herein are primarily designed for use by government and non-profit organizations in assessing the direct and indirect costs of operations for the services they provide to communities.

These various utilities are referred to herein as the Pricing and Service Sustainability (PASS) application. The PASS application may in various aspects be implement as software for stand-alone use in computer systems. In another arrangements, the PASS application may be implemented in a client server environment (e.g., web-based). In further arrangements, related business methods are provided where the PASS applications is combined with a product and service model for generating revenue through hosted enterprise software license sales, and subsequent managed services.

The PASS application provides planning, budgeting, pricing, and measurement tools for individual services provided by an agency. The output and outcome measurements of PASS result in accurate fee structures that are based upon real costs and a pre-determined cost recovery or subsidy allocation goals. The software integrates all costs from existing financial management programs, allowing users to reconcile their fiscal and political realities while reflecting the values of the community in their user fee structures.

The PASS application provides a planning module/functionality that accounts for funding sources (e.g, annual budget, grants, user fees etc.) facilities (types, uses thereof), programs offered at various facilities and personnel who operate the programs and facilities.

The Pass application also incorporated the metrics form the planning module with a budget module/functionality such that budgets may be tied to funding sources with consideration of service objectives. For instance, different programs and the personnel to staff such programs may be tied to specific budget sources.

Importantly, the PASS application supports a pricing module/functionality that allows for determining pricing and fees that can enhance or maximize service objectives within funding support levels. In this regard, the PASS application can set pricing levels that reflect a true cost of the services provided. However, based on service objectives, these costs may be subsidized for some programs (e.g., higher priority programs that serve larger populations) and/or unsubsidized for other programs. Such service objective are a system input.

Further, the PASS application provides a measurement module/functionality that allows for periodic measurement off all programs and facilities to ensure financial integrity and ability to adjust as needed (cost recovery, subsidy levels, # of courses running at minimum or above, etc. . . . ).

The PASS application is a comprehensive software package for financial management in parks and recreation. It uses the service objectives and operational budgets along with preferred cost recovery and subsidy levels to determine fees for rentals, courses, and memberships. Within the PASS application there are philosophical decisions to be made inside each module. These management level decisions reflect the organization's preferred pricing, cost recovery and subsidy strategies. For instance, it may be desirable to recover all costs associated with some services while recovering fewer costs (e.g., subsidizing) other services. The PASS application allows implementing such varied levels of cost recovery.

There are six major areas within PASS. They include an:

1. Expense Module

2. Facility Module

3. Rental Module

4. Course Module

5. Membership Module

6. Reporting Module

Expense Module—Allocates the organization's budget to administration, program, facility, and other expenses. The costs for each area are categorized as direct or indirect. Established expenses are then automatically applied to the subsequent tool modules.

Facility Module—Calculates the fees for facility usage by courses and rentals. These fees are based on the established expenses as well as the organizations preferred cost recovery rates. Established fees are then automatically applied to the rental and course modules. The user also identifies and specifies all facilities under operation in the organization and enables the highest level of categorical detail, such as itemizing a specific lane in a pool. The detailed information enables management to make core decisions as to the raising or lowering of fees and the Facility Module automatically updates all data accordingly after one input is changed.

Rental Module—Calculates the revenue generated by external costumer facility usage. Revenue numbers are calculated with projected facility rental numbers and the established rental fees. The module allows the user to input projected hours and cost recovery levels for each unit. From this information, the projected revenues for each unit are shown and the remaining facility expense flows into the Courses and Membership Modules.

Courses (Classes) Module—Identifies the direct and indirect costs of running the organization's programs. Fees for each course are set based on these costs and the organization's preferred cost recovery rate. PASS will also allow for the management decision of applying a cost recovery rate to each class and will show the resulting subsidy. The true cost of offering a course (activity, class, etc.) is a dilemma that all parks and recreation departments struggle with every year. The Course Module solves that problem.

Membership Module—Sets the organization's membership and entrance fees. These fees are calculated based on the total expenses yet to be recovered (after the Rental and Course Modules) and the preferred cost recovery rates. After the user inputs all their membership plan data, the tool automatically calculates the per user/pass fee, allows for Management Decisions and shows any remaining subsidy per Membership Area.

Reporting Module—The robust reporting capability of PASS enables users to generate reports that respond to their individual organizational cost recovery and subsidy allocation philosophy and the measurable outcomes targeted. The reporting capacity analyzes pricing strategies, on-going funding and budgets, funding allocation, subsidy distribution tactics, and financial management strategies. The Reports Module allows quick easy access to an organization's pertinent financial data. Reports are fully customizable, but numerous frequently used reports are included.

The PASS application and related business methods provide a number of offerings to allow organizations to achieve the goals of better financial management. These include, without limitation: PASS Software—Hosted enterprise software that provides organizations with the ability to define and manage their financial plans and cost recovery strategies, consistent with their overall service philosophy. This includes software license, implementation, and maintenance; Cost Recovery Consulting—Professional services designed to help organizations define, refine, and improve their financial planning and cost recovery approaches; and/or Managed Services—For clients who have licensed the tool, providing additional professional services to run cost recovery scenarios and providing analysis for complex scenarios, budgeting, and other needs.

Other aspects include benchmark access. In such an aspect, data may be collected from different uses of the PASS application and compiled to provide comparative data (e.g., benchmark data) for use in determining, for example, appropriate funding levels that may be tied to, for example, demographics. This benchmark service will allow clients to compare their cost recovery data and answers to others of similar size, philosophy, etc. This type of data is highly valuable, but very difficult to get for most organizations. In addition, there are a number of adjacent market opportunities for the organization, including expansion of the scope of cost recovery capabilities beyond parks and recreation, as well as expansion outside of the United States. The management team will continue to assess appropriate expansion opportunities and address them when the market timing is optimum.

### BRIEF DESCRIPTION OF THE FIGURES

FIG. 1 illustrates a home page.

FIG. 2 illustrates an expense module home page.

FIG. 3 illustrates expense inputs.

FIG. 4 illustrates a home page of a facility module.

FIG. 5 illustrates a facility entry page.

FIG. 6 illustrates a home page of a rental module.

FIG. 7 illustrates a rental entry page.

FIG. 8 illustrates a home page of a course module.

FIG. 9 illustrates a course entry page.

FIG. 10 illustrates a course entry page.

FIG. 11 illustrates a course entry page.

FIG. 12 illustrates a home page of a member module.

FIG. 13 illustrates a membership entry page.

FIG. 14 illustrates a membership entry page.

FIG. 15 illustrates a membership entry page.

FIG. 16 illustrates a membership entry page.

### DETAILED DESCRIPTION

Parks, beaches, and other recreational facilities contribute $730 billion per year to the U.S. economy, support nearly 6.5 million jobs, and contribute to cleaner air and water and higher property values. Despite record spending on parks at the state and local level, the acreage of parkland per resident in urban areas is declining. While significant investments are being made in the National Park Service for its 2016 centennial, the agency's facilities still face a $7 billion maintenance backlog.

Americans frequent their state and local parks more often than national parks. State parks entertained more than 730 million visitors during the period July 2006 through June 2007, and the vast majority (90.9%) were day visitors. During this time, states acquired 56,681 acres of parkland and spent more than $463 million on new construction of state park improvements to accommodate growing populations.

States and territories received nearly $28 million in federal funds in 2007 through the Land and Water Conservation Fund Program. However, they reported more than $15 billion in unmet needs, a significant increase over the amount reported in 2006.

The 75 largest cities in the U.S., home to more than 51 million Americans, reported spending just under $5 billion in fiscal year 2006 on urban park and recreation facilities and programming, adding more than 5,000 acres of green space. Despite such record spending, the amount of parkland per resident has declined due to rapid increases in population. In 2006, the 60 largest cities averaged 18.88 acres of parkland per 1,000 residents. In 2007, that number fell to 16.72 acres per 1,000 residents. As suburban areas become more densely populated with infill developments, parkland will become more important in maintaining residents' health, safety, and stable property values.

Parks enjoy broad public support. Even in the current troubling economic environment, voters in November 2008 approved a record amount of new funding measures for parks and open space. Voters supported 62 of 87 (71%) conservation finance ballot measures, representing a commitment to spend $7.3 billion on parks and open space. The $8.4 billion total approved by ballot measures in all of 2008 is the highest single-year amount in 10 years.

Notwithstanding such broad public support, economic realities have driven forced many park and recreation organizations (e.g., agencies) to adopt a cost recovery/subsidy allocation philosophy that better represents the true cost of providing such services. These agencies may have established their philosophy, including cost recovery and subsidy allocation goals, in a variety of ways: a) arbitrarily; b) based upon industry benchmarks; c) based upon past departmental cost recovery subsidy allocation levels; or d) based upon the adoption of a systematic cost recovery/subsidy allocation philosophy that articulates the benefit of each public service to the overall community (all taxpayers) as opposed to the individual user and therefore, primary beneficiary.

Provided herein is a Pricing and Service Sustainability (PASS)application developed to help such agencies of assess the true costs of service provision or the “real cost of doing business” realized in governmental and nonprofit systems. PASS is, in essence, a software program and technical tool designed to account for all direct and indirect costs of service provision. In one embodiment, PASS is a provided in a web-based platform that is a financial planning, budgeting, pricing, and measurement tool. PASS implementation results in a number of distinctive characteristics. Among these are accurate cost accounting and allocation, and fee structures that are based upon real costs and pre-determined cost recovery and subsidy allocation goals. PASS™ integrates all costs and data sets from existing software programs (e.g. financial systems, registration systems).

A series of modules allow for total accountability of all costs, appropriately distributing them to each individual organizational service, methodically, logically and responsibly. Subsequently, adaptable reporting allows the agency to design the types of useful reports it needs to articulate and illustrate financial information to assist staff in making justifiable and defensible decisions.

There are six major modules within PASS. They include an:

1. Expense Module

2. Facility Module

3. Rental Module

4. Course Module

5. Membership Module

6. Reporting Module

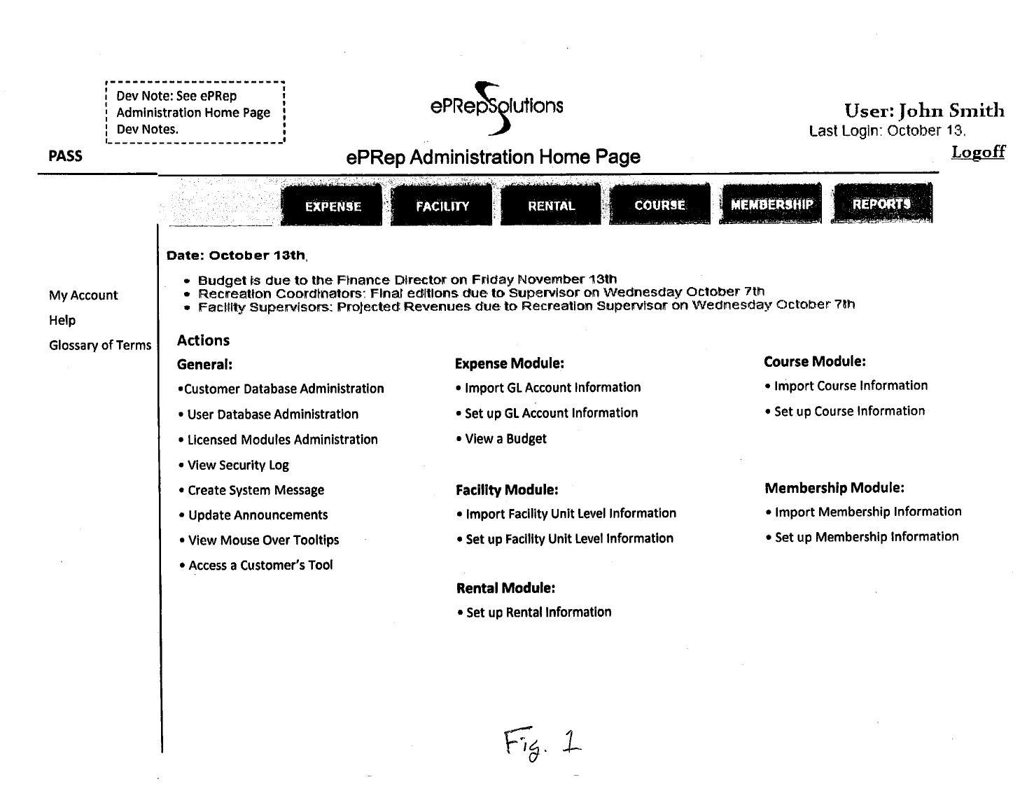

During use of the system, authorized users (e.g., password authorized users) log into the system and access a home page. See FIG. 1. At this point, the user may receive information that is specific to that user's account (e.g., notices pop up reminders etc.). Further, it will be appreciated that the users level of access may vary. In a situation where a user has full access, they may access the different modules via the home page to enter information therein and/or utilize the information together to achieve overall management goals of the organization.

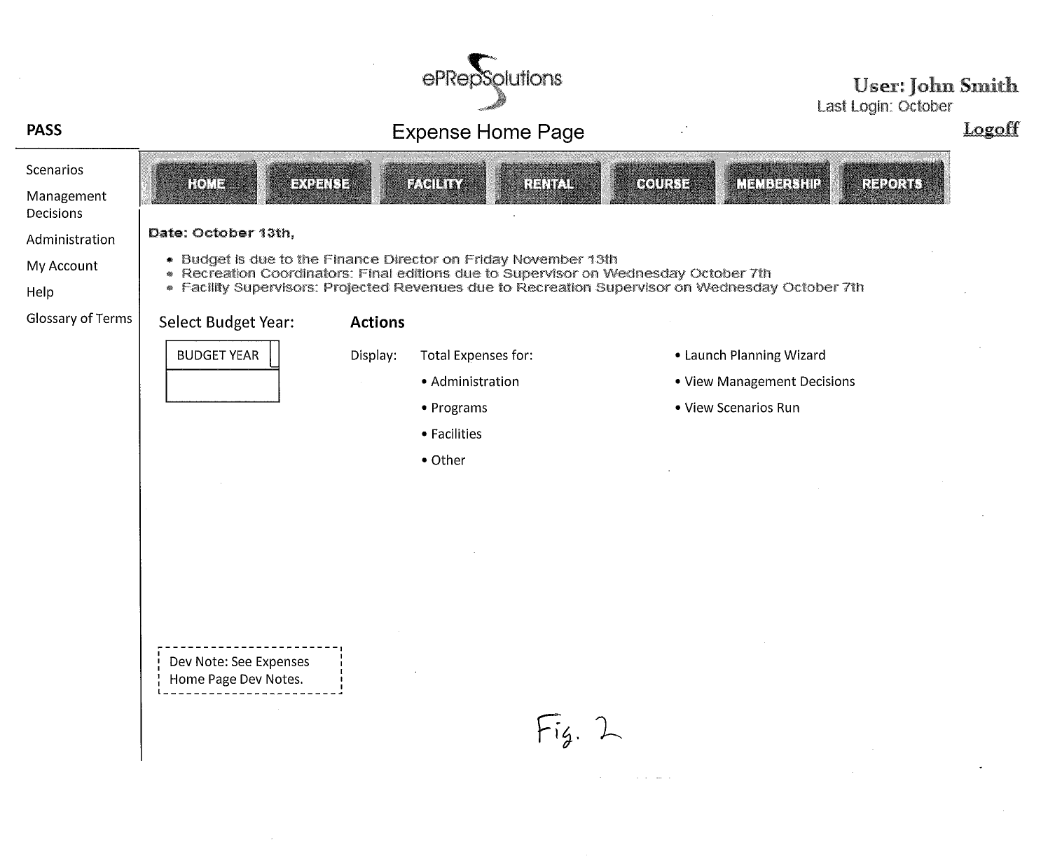

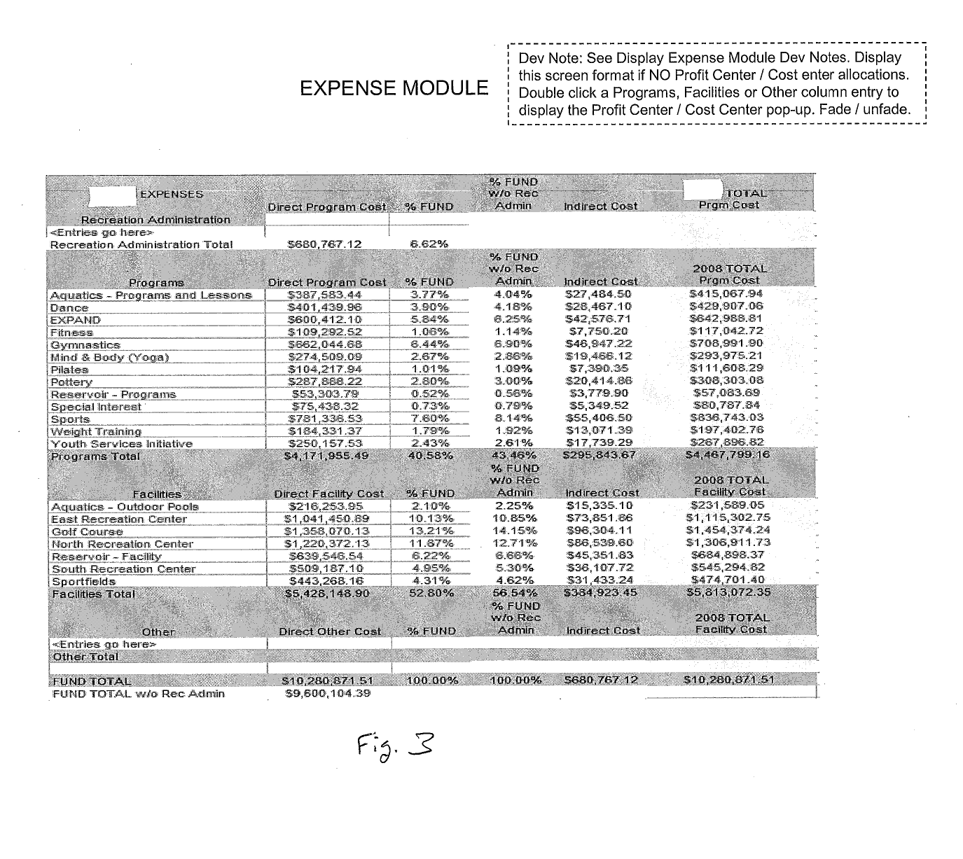

FIG. 2 illustrates access to the expanse module and in particular an exemplary expense module home page. In the expense module a user is able to allocate an organization's budget to administration, program, facility, and other expenses. The costs for each area are categorized as direct or indirect. See e.g., FIG. 3. Established expenses are then automatically applied to the subsequent tool modules such that, for example the total costs or proposed reimbursement rates may be determined on a per program basis. It will be appreciated that while illustrated in FIG. 3 as overall costs per program, that subsequent entry sheets/spreadsheets allow for identifying specific costs per program (e.g., labor etc.).

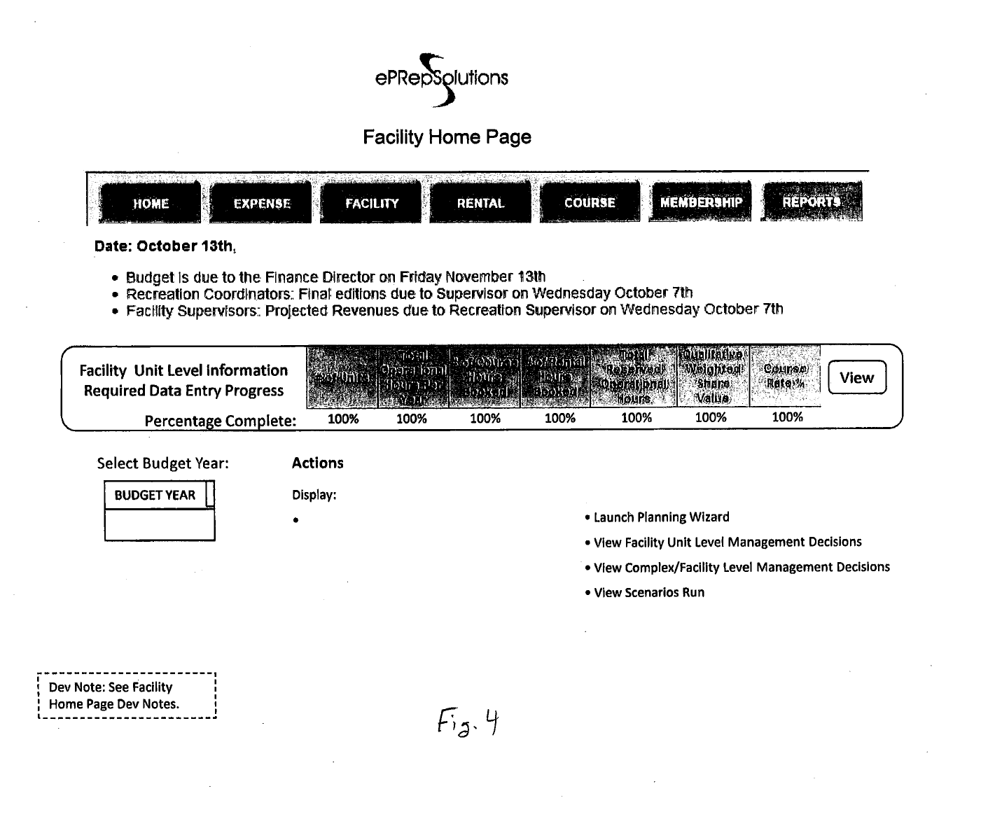

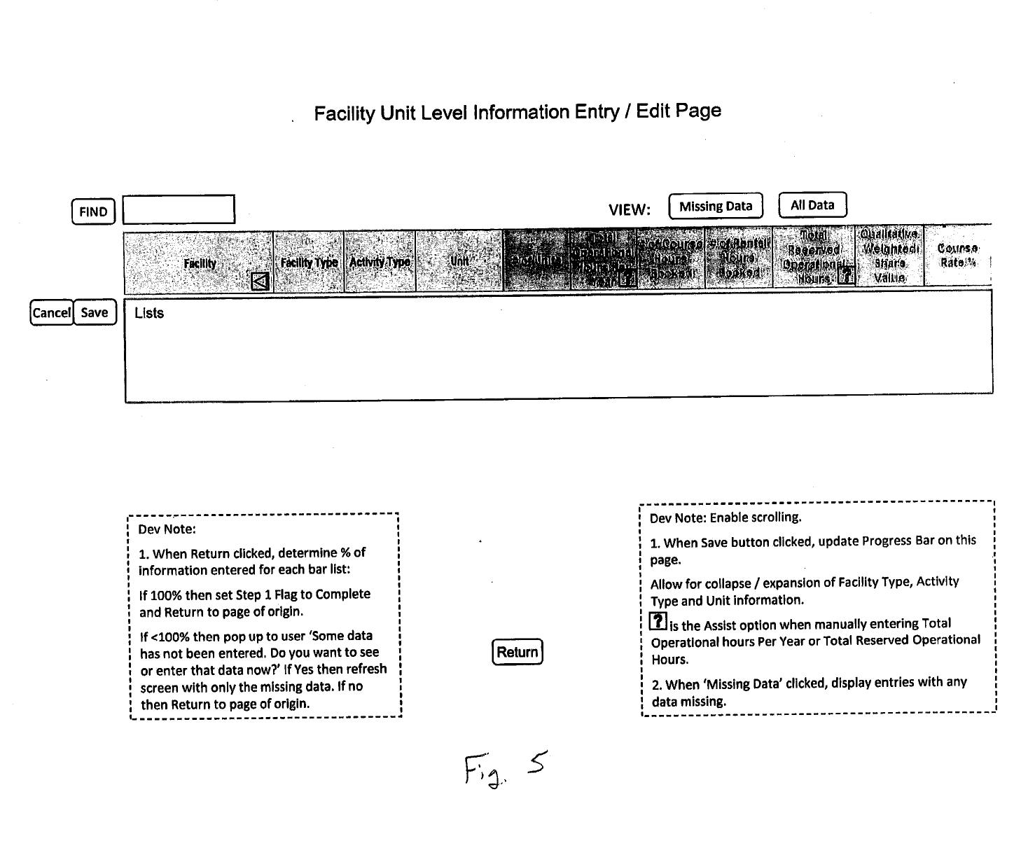

FIG. 4 illustrates the home page of the Facility Module. This module allows for calculating fees for facility usage by courses and rentals. These fees are based on the established expenses as well as the organizations preferred cost recovery rates. Established fees are then automatically applied to the rental and course modules. The user also identifies and specifies all facilities under operation in the organization and enables the highest level of categorical detail, such as itemizing a specific lane in a pool. The detailed information enables management to make core decisions as to the raising or lowering of fees and the Facility Module automatically updates all data accordingly after one input is changed. As will be appreciated, each facility will include an individual entry page that allows for entering specific information for that facility. See e.g., FIG. 5.

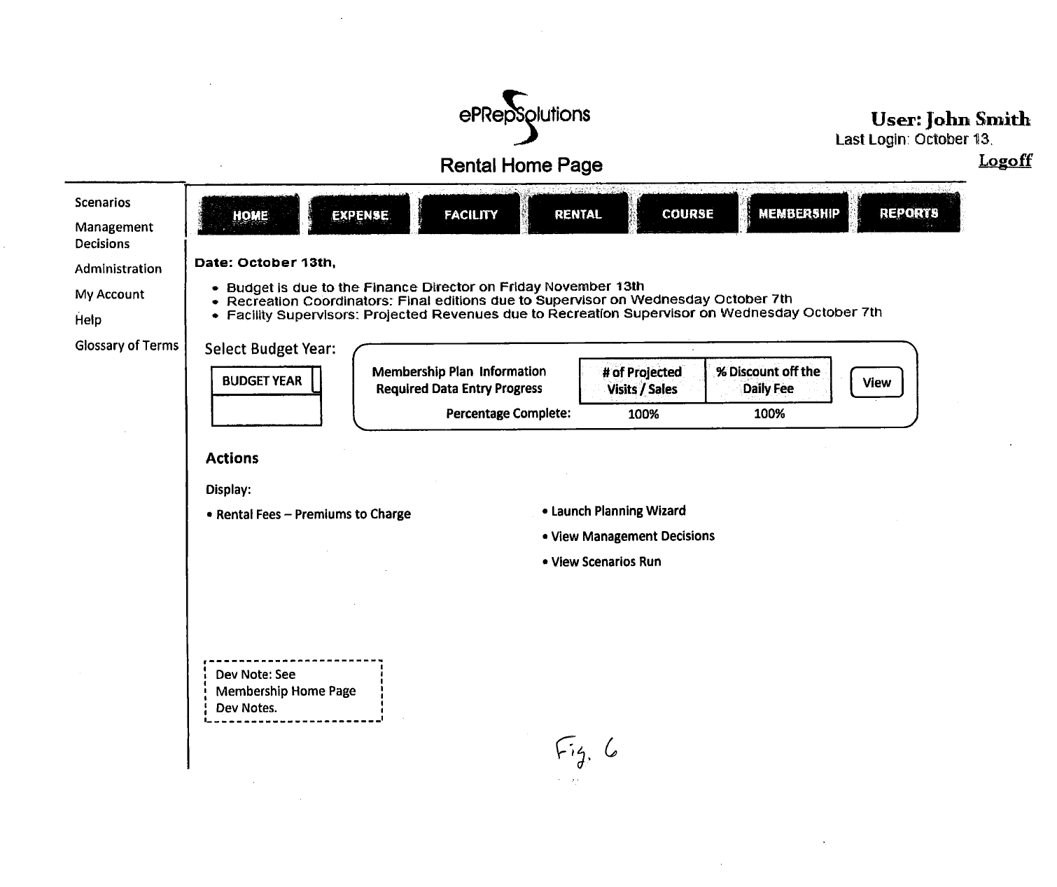

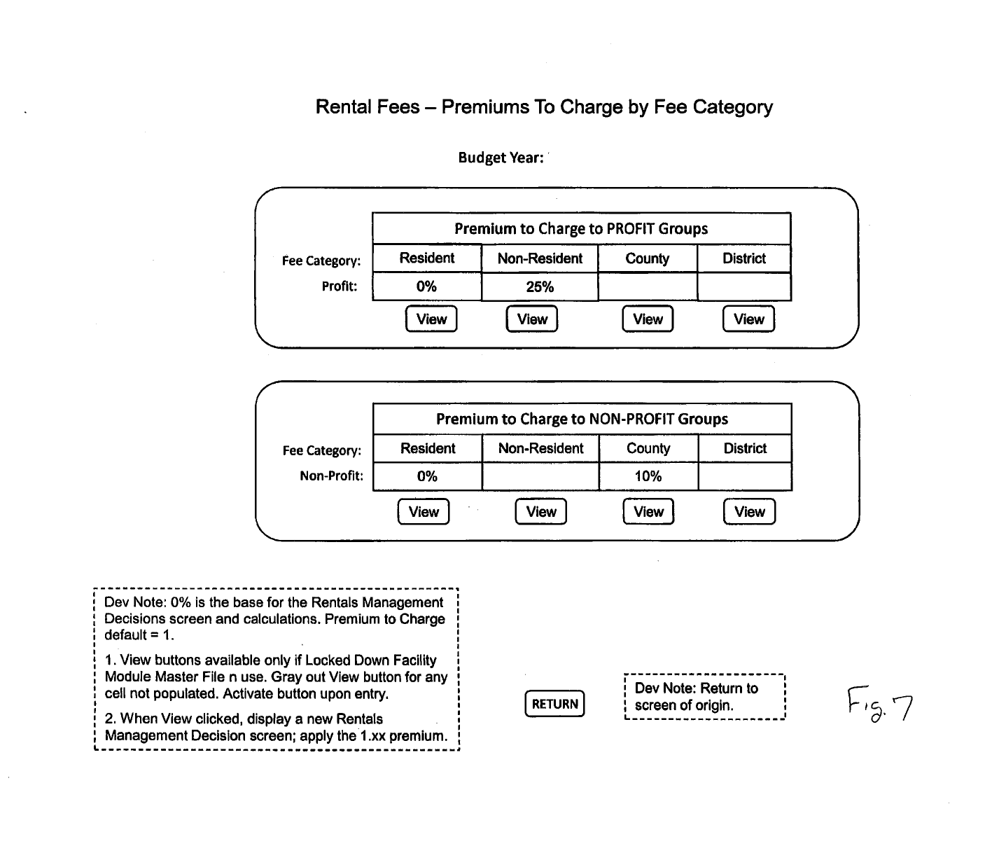

FIG. 6 illustrates a rental module home page. The rental module calculates the revenue generated by external costumer facility usage. Revenue numbers are calculated with projected facility rental numbers and the established rental fees. The module allows the user to input, inter alia, projected hours and cost recovery levels for each unit. See for example FIG. 7, which illustrates one of the variable input pages that allows users to adjust rates for different users. Of course, entry pages also exist for different facilities. From this information, the projected revenues for each unit are shown and the remaining facility expense flows into the Courses and Membership Modules.

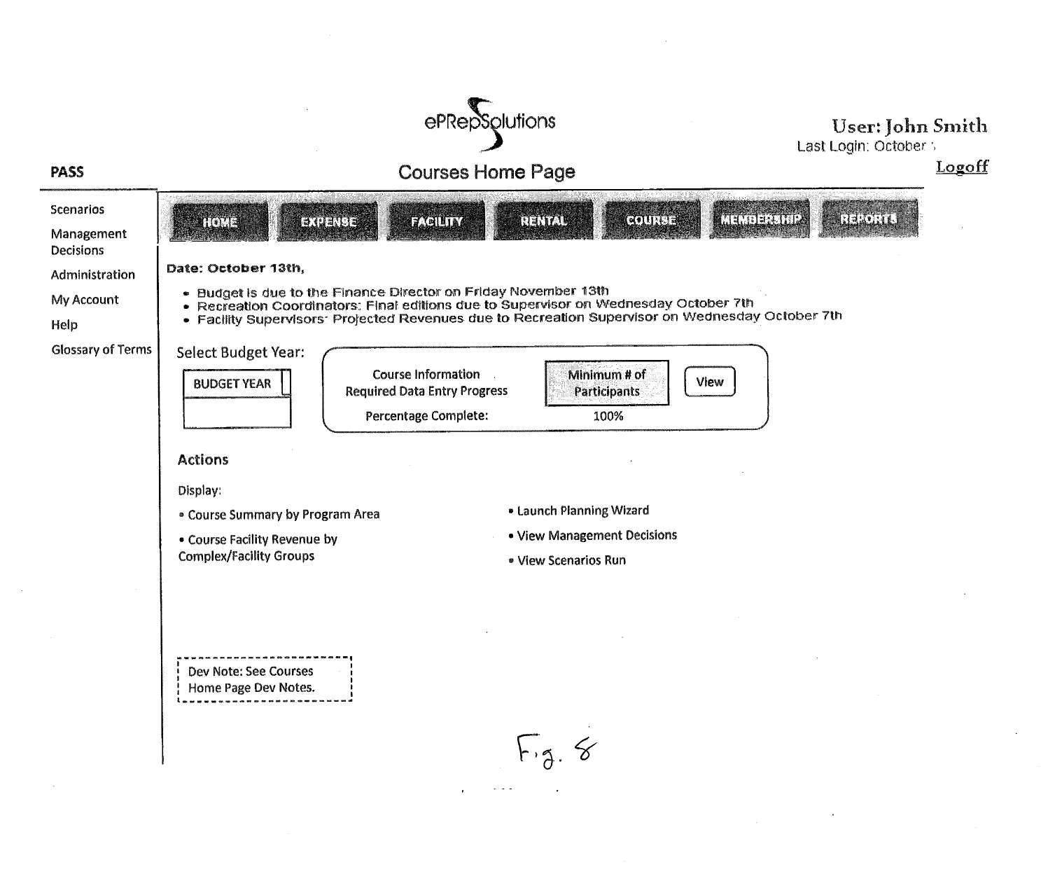

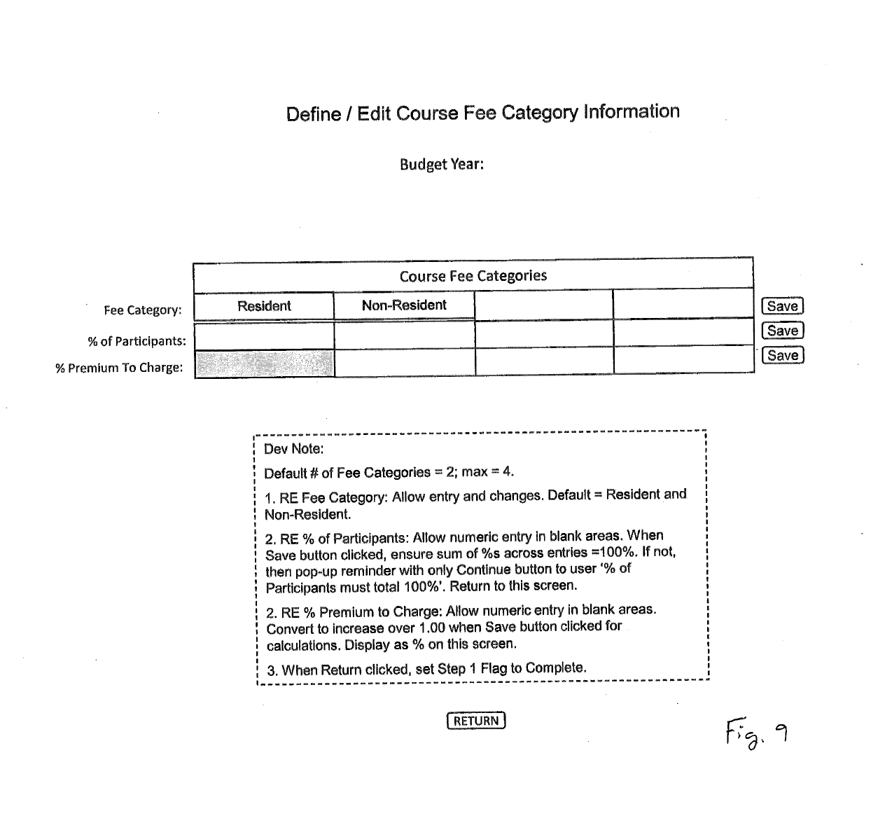

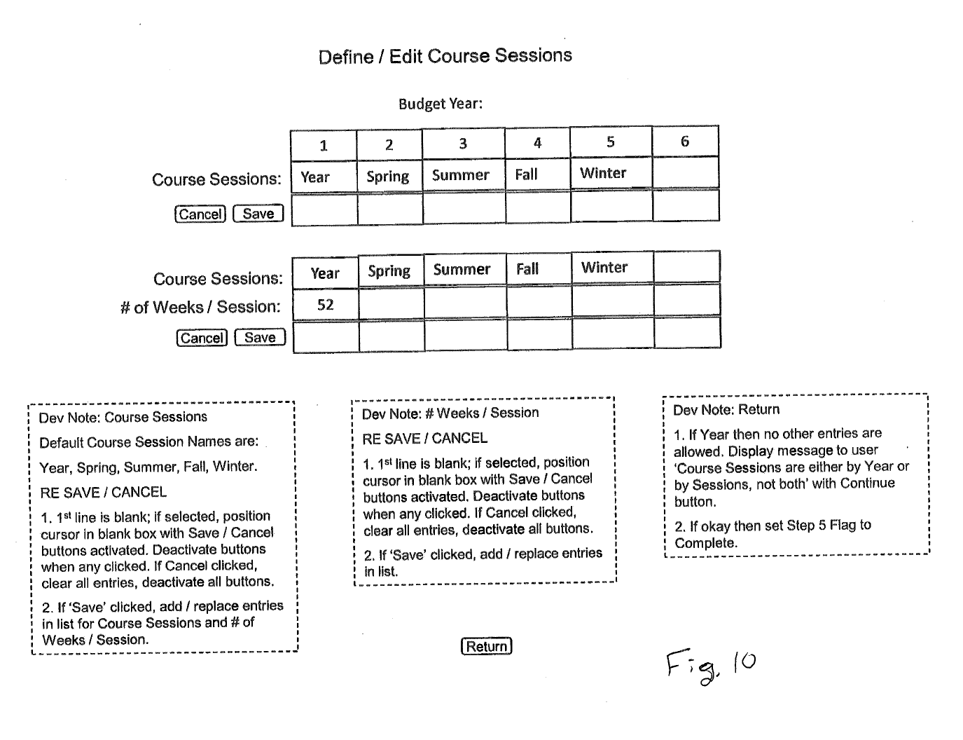

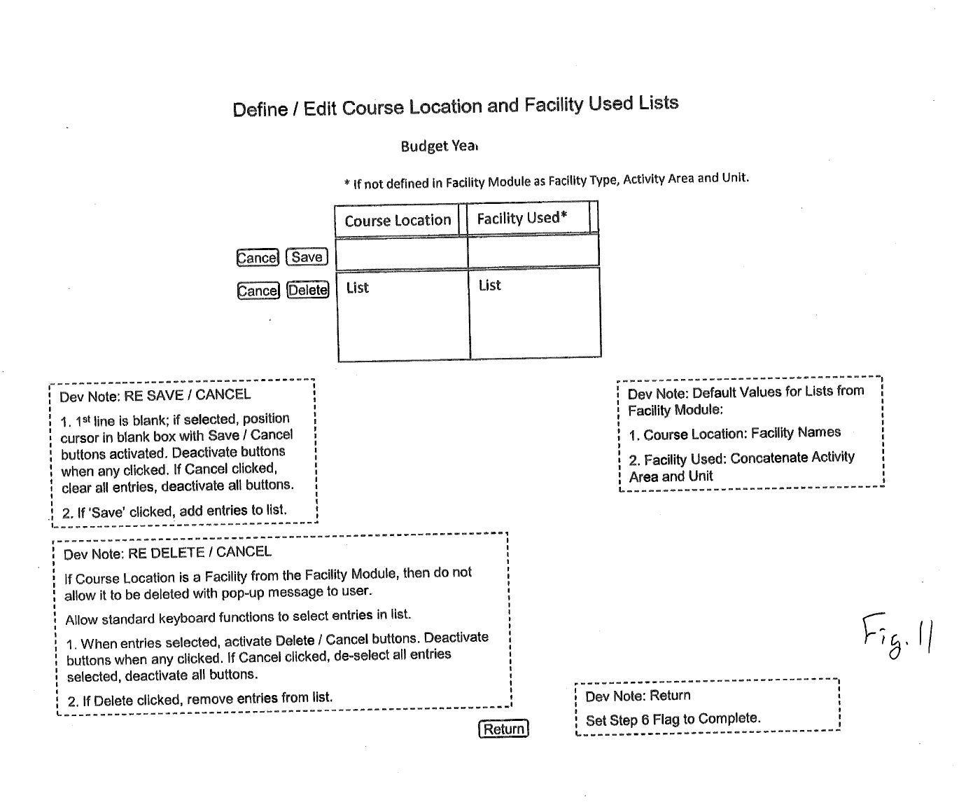

FIGS. 8-11 variously illustrate the course and membership module. Specifically, FIG. 8 illustrates the Course home page which allows users to enter information regarding various courses/programs. In general, the courses (classes) module identifies the direct and indirect costs of running the organization's programs. Fees for each course are set based on these costs and the organization's preferred cost recovery rate. In this regard, users can set course fees (see FIG. 9). PASS will allow for either management decision of applying a cost recovery rate and/or suggesting a cost recovery rate (fee) to each class and will show the resulting subsidy. The true cost of offering a course (activity, class, etc.) is a dilemma that all parks and recreation departments struggle with every year. The Course Module solves that problem. Of course, this requires that various information be entered regarding each course (see FIG. 10) and the facilities utilized to provide that course (see FIG. 11).

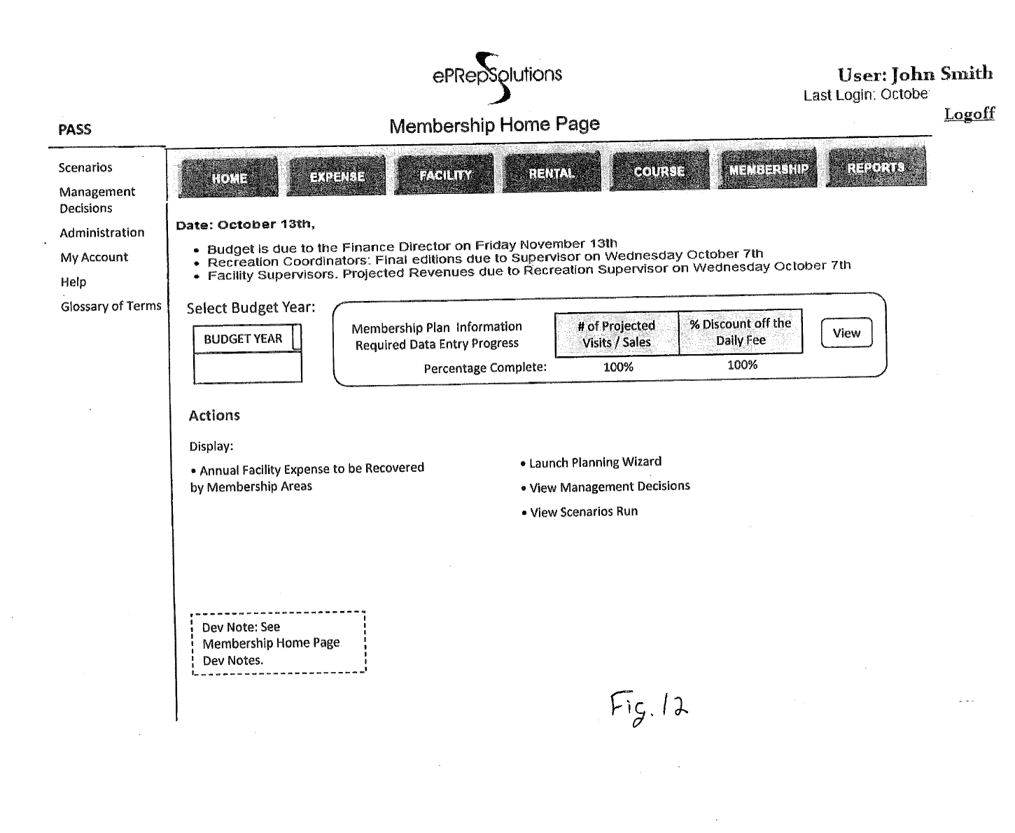

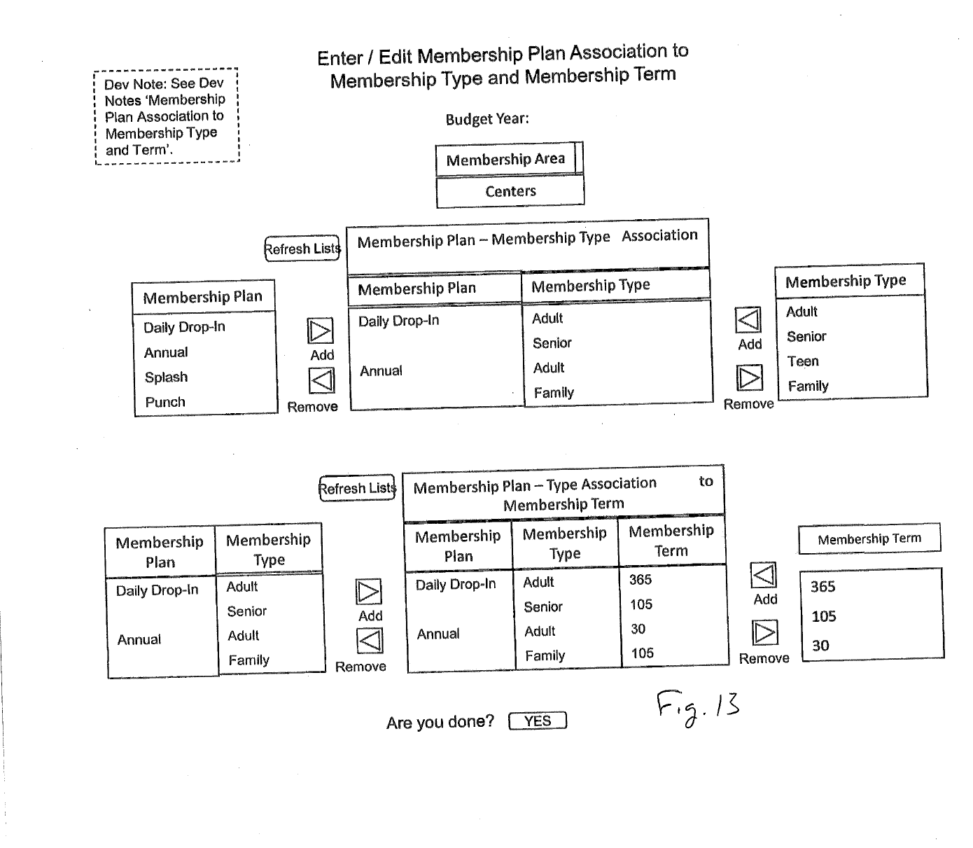

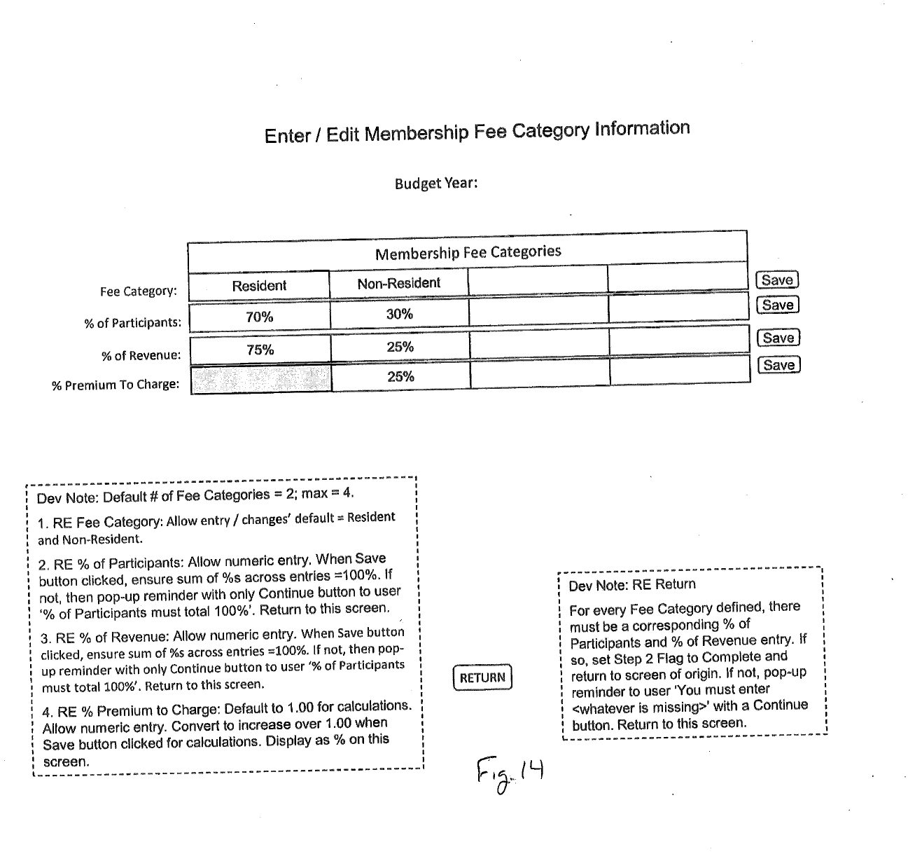

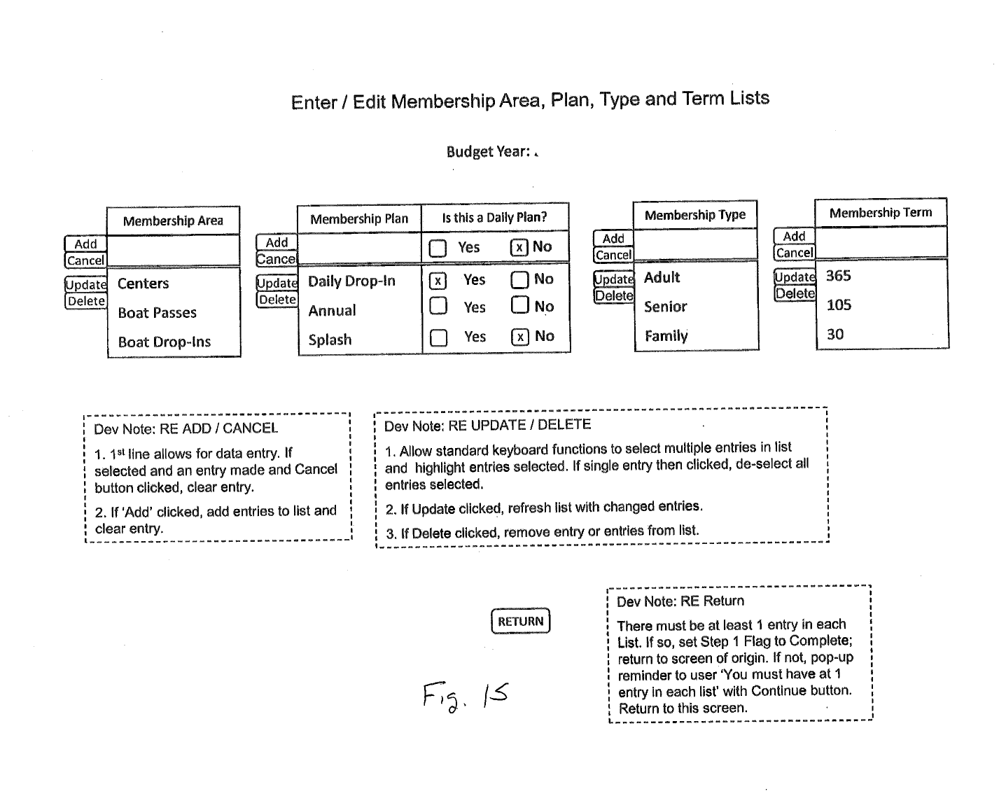

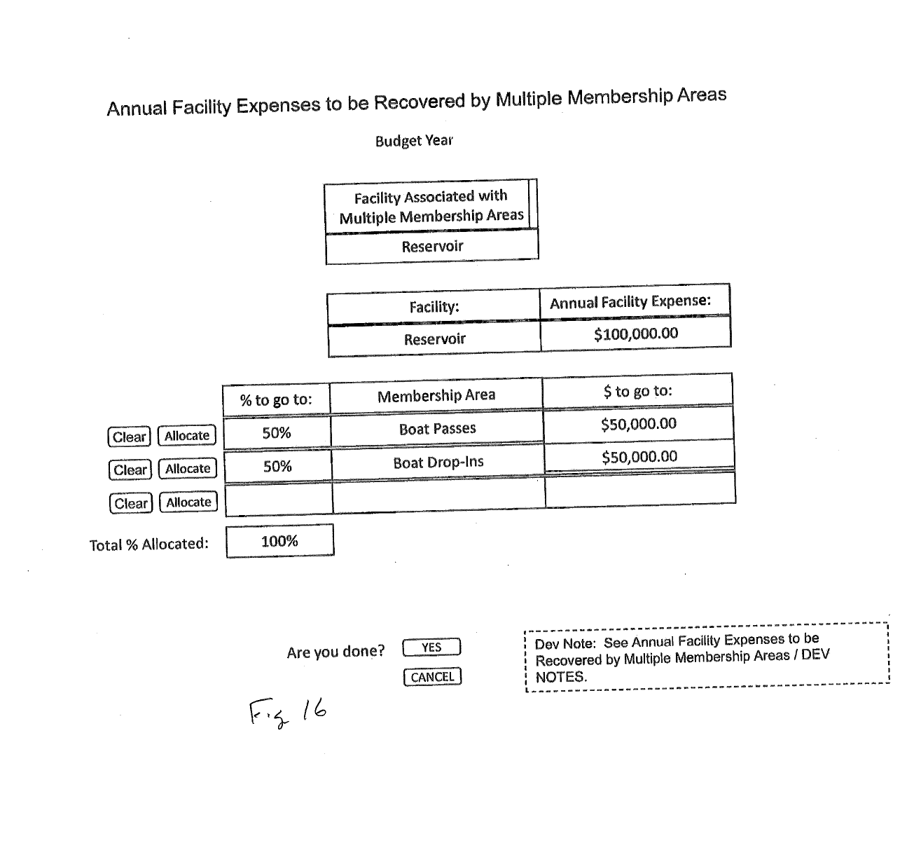

FIG. 12-16 illustrates portions of the membership module that allows for setting the organization's membership and entrance fees. These fees are calculated based on the total expenses yet to be recovered (after the Rental and Course Modules) and the preferred cost recovery rates. After the user inputs all their membership plan data, the tool automatically calculates the per user/pass fee, allows for Management Decisions and shows any remaining subsidy per Membership Area.

Finally, the system includes a reporting module that allows users to generate reports that respond to their individual organizational cost recovery and subsidy allocation philosophy and the measurable outcomes targeted. The reporting capacity analyzes pricing strategies, on-going funding and budgets, funding allocation, subsidy distribution tactics, and financial management strategies. The Reports Module allows quick easy access to an organization's pertinent financial data. Reports are fully customizable, but numerous frequently used reports are included.

As illustrated in the various modules, users are allowed to enter detailed information about various aspects of their operations and services. The PASS application can then utilize this disparate information to provide costs for each service that includes direct and indirect costs. By including all of the costs associated with providing services (e.g., including facilities), the costs for each such service may reflect a more accurate portrayal of the actual costs to provide the services. Users may utilize this information to set fees that more closely reflect the actual costs associated with the services. Of course, users may also decide which services to subsidize (e.g., price below actual cost) and/or services that demand a premium (e.g., above actual costs)

1. A computer readable program product for use in generating product pricing in governmental agencies such as parks and recreational departments, comprising:
a computer useable medium and computer readable code embodied therein, the computer readable program code comprising:
an objectives input unit, said unit operative for receiving service information for the provision of at least one service;
a planning unit for receiving resources inputs regarding facilities programs, personnel and cost associated with said resource inputs;
a pricing unit, wherein said pricing unit is operative to utilize said service information and said resources inputs and generate pricing information associated with said at least one service.

2. The program product of claim 1, wherein said computer readable program code further comprises:
a budget unit, wherein said budget unit is operative to receive inputs regarding at least one of funding sources and financial budgets, wherein said pricing unit further utilizes said budget unit to generate said pricing information.

3. The program product of claim 1, wherein any of the above noted units may further include one or more of multiple modules for receiving information regarding any of:
expenses
facilities;
rentals;
courses;
memberships; and
reports.

4. The program product of claim 3, wherein said expenses module is operative to receive inputs regarding budget allocation to at least one of:
administration;
program;
facility; and
miscellaneous; and
wherein expenses from said expenses module are applied to one or more additional modules.

5. The program product of claim 4, wherein inputs are categorized as direct or indirect.

6. The program product of claim 3, wherein said facility module is operative to receive inputs regarding fees for facilities usage based at least in part on one or more of:
established expenses;
preferred cost recovery rates.

7. The program product of claim 3, wherein said rental module is operative to receive inputs regarding revenue generated by external customer facility usage based on one or more of:
rental hours; and
recovery level.

8. The program product of claim 3, wherein said courses module is operative to receive inputs regarding programs offered by an organization and generate fees for said courses based on one or more of:
costs;
recovery level.

9. The program product of claim 8, wherein said course module further generates an actual cost associated with the programs.

10. The program product of claim 3, wherein said membership module is operative to receive inputs regarding an organizations members and establish entrance and/or membership fees based on least one of:
costs;
total expenses yet to be recovered;
recovery levels.

11. The program product of claim 3, wherein said reports module is operative to generate outputs regarding at least one of:
cost recovery;
subsidy;
pricing strategies;
comparative organizations.

12. The program product of claim 1, wherein said program product is accessible via a distributed network.

13. The program product of claim 12, wherein said program product is web-hosted.

14. The program product of claim 13, wherein said web-hosted product is part of a subscription service.
